(19) United States
(12) Patent Application Publication
(10) Pub. No.: US 2018/0340471 A1
(43) Pub. Date: Nov. 29, 2018

(54) PUMP BEARING FLOW CONTROL

(71) Applicant: EATON CORPORATION, Cleveland, OH (US)

(72) Inventors: Robert Joseph Nyzen, Hiram, OH (US); Martin A. Clements, West Chester, OH (US)

(21) Appl. No.: 15/771,214

(22) PCT Filed: Nov. 1, 2016
(86) PCT No.: PCT/US2016/059891

§ 371 Date: Apr. 26, 2018

Related U.S. Application Data
(60) Provisional application No. 62/250,120, filed on Nov. 3, 2015.

(51) Int. Cl. F02C 7/22; F04B 7/00

(52) U.S. Cl. CPC F02C 7/22; F04B 7/0057

(57) ABSTRACT

A gear pump comprising a bearing and first and second high pressure feeds from a bearing lube supply source to a lube pad disposed on an inside diameter of the bearing. Each of the first and second high pressure feeds includes an orifice. At least one of the first and second high pressure feeds includes a valve configured to selectively control the feed path and orifice within which it is installed. A method of controlling flow to a gear pump bearing is also disclosed.

This application claims the priority benefit of U.S. provisional application Ser. No. 62/250,120, filed Nov. 3, 2015, the entire disclosure of which is expressly incorporated herein by reference.

### BACKGROUND

Many fluid pumps, such as aircraft engine fuel gear pumps, have pressure fed bearings to improve the load carrying capability of the bearing, see for example commonly owned U.S. Pat. No. 8,959,920 and U.S. Pat. No. 8,235,679, the entire disclosures of which are expressly incorporated herein by reference. At certain operation conditions, such as, for example, engine windmill where the speed is low and the bearing loads are lower, there is excessive bearing flow that results in over-sizing the pump.

Consequently, a need exists for a pump bearing flow arrangement that satisfies desired load carrying capability for the bearing, but addresses the excess bearing flow issue that undesirably results in over-sizing the pump.

### SUMMARY

This disclosure provides a bearing flow control arrangement that allows for a portion of bearing flow to be turned off at certain conditions and retains the capability of full flow when necessary at high bearing load.

In a preferred arrangement, a pump such as a gear pump includes a bearing having a cavity. A journal or shaft is rotatably received in the bearing cavity. First and second bearing flow feed paths from a bearing lube supply source provide a bearing fluid to the cavity. A control mechanism selectively alters the amount of bearing fluid flow through at least one of the first and second bearing flow feed paths to the bearing cavity.

The control mechanism includes a valve operatively associated with the second bearing flow feed path configured to selectively control the bearing fluid flow.

The valve is preferably an on/off valve to selectively permit/prevent bearing fluid flow through the second feed path, respectively.

A sensor provides a signal representative of at least one of (a) pump speed, (b) pump load, and/or (c) temperature of the bearing lube fluid.

The sensor monitors at least system pressure rise in one preferred embodiment.

The sensor monitors at least pressure downstream of the pump in another preferred embodiment.

The sensor monitors at least rotational speed of the journal in yet another preferred embodiment.

In still another embodiment, the sensor monitors temperature of the bearing fluid, or the sensor monitors a combination of two or more of system pressure rise, downstream pump pressure, journal rotational speed and bearing lube fluid temperature.

Both of the first and second feed paths separately communicate with a bearing lubrication pad of the bearing.

A method of controlling flow to a pump bearing includes providing a bearing and at least different, first and second pressurized feed paths from a bearing lube supply source to a lube pad disposed on an inside diameter of the bearing, each of the first and second pressurized feed paths includes an orifice and at least one of the first and second pressurized feed paths includes a valve configured to selectively control bearing lube flow (e.g., fuel) through the feed path and orifice within which it is installed. The method includes sensing at least one condition of pressure or speed of the pump, and operating the valve in response to the either the sensed pressure or sensed pump speed.

The valve operating step includes altering bearing lube flow through the at least one pressurized feed path.

The flow altering step includes selectively shutting off/permitting bearing lube flow through the at least one pressurized feed path.

The bearing lube flow is provided through both of the first and second lube flow feed paths in response to either a detected increased pressure rise or detected increased pump speed.

The sensing is, for example, hydraulic or electronic sensing that monitors one or more pump conditions (e.g., pressure, pump speed, bearing fluid temperature, etc.).

The method includes using fuel as the bearing lube flow.

A primary advantage of the present disclosure is a pump bearing flow arrangement that satisfies desired load carrying capability for the bearing.

Another benefit resides in the ability to address excess bearing flow issues.

Yet another advantage relates to not over-sizing the pump.

Still other benefits and advantages will become apparent to those skilled in the art upon reading and understanding the following detailed description.

### BRIEF DESCRIPTION OF THE DRAWINGS

FIG. 1 is an illustration of a pump including a pump bearing flow control according to an embodiment of the present disclosure.

### DETAILED DESCRIPTION

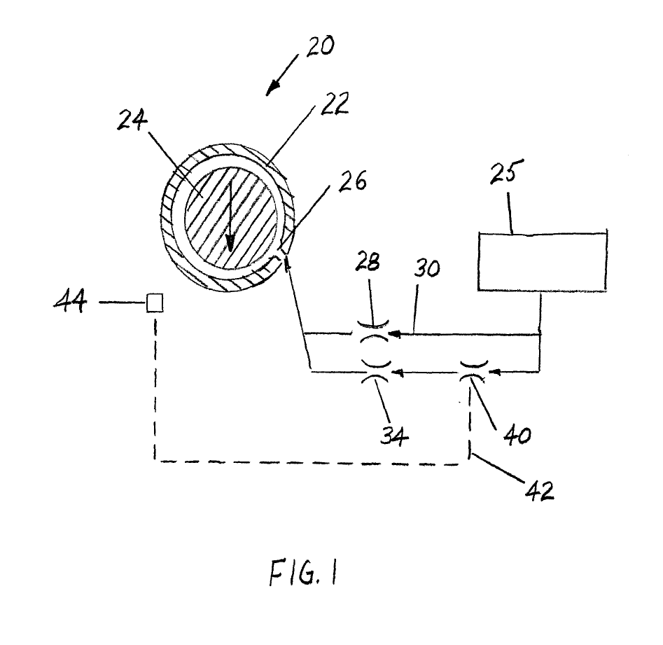

Referring now to the drawing, which is not intended to limit the invention, FIG. 1 illustrates a portion of a pump such as a conventional gear pump 20 that includes a highly loaded pump bearing 22 that may be suitable for use, for example, as an aircraft engine fuel pump. In the illustrated embodiment, the bearing 22 is a journal bearing that supports a journal or shaft 24. The bearing 22 includes a pressurized feed or high pressure feed from a bearing lube supply source 25 to a recess or pocket 26 (commonly referred to as a lube pad) disposed on an inside diameter of the bearing 22.

An orifice 28 is placed in a bearing lube supply first flow feed path 30 and is used to regulate the amount of fluid (e.g., fuel) flow into the bearing 22. This feature improves the load carrying capability of the bearing 22 for either hydrostatic contribution and/or the ability to generate a better hydrodynamic fluid film. The bearing 22 may be sized based on various factors, including, without limitation, temperature, speed, and applied load. The use of a pressure feed is required as temperatures increase, speeds decrease, and loads increase. The amount of fluid fed to the bearing 22 needs to increase as these parameters change. However, in the case of aircraft engine fuel pump bearings, it is typically take-off conditions that size the bearing 22, but the leakage is very high at windmill conditions where the speeds are low and the loads are low. This may result in a pump designer adding volumetric capacity to the pump 20 to accommodate this excess leakage, which results in excess power at other operating conditions.

It is desirable to either turn off all or a portion of the bearing flow at conditions where it is not needed. In an embodiment of the present disclosure, this is accomplished by providing a second bearing lube flow feed path 32 with an accompanying orifice 34 to each bearing 22. The second bearing lube flow feed path 32 is disposed in parallel with the first bearing lube flow feed path 30 between the bearing lube supply source 25 and the lube pad 26. At least one of the first and second bearing lube flow feed paths 30, 32 extending between the bearing lube supply source 25 and the lube pad 26 may include a valve 40 controlled by either an electronic signal or hydraulic signal 42 from a sensor 44 to selectively control (e.g., turn on/off), for example, bearing lube flow from the source 25 through the second bearing lube flow feed path 32 within which the valve is installed, thus reducing the bearing leakage flow. The first and second bearing lube flow feed paths 30, 32 and orifices 28, 34, respectively, may be the same or of different sizes depending on the design and if the need exists to maintain a desired flow to the bearing 22.

Another embodiment of the present disclosure may be configured to include more than two bearing lube flow feed paths 30, 32 to various lube pads 26 and may be extended to more than two orifices 28, 34 and/or valves 40 if multiple flow levels are required in the design of the bearing 22. It is also possible that in some operating conditions or situations all of the fluid flow may be turned off to the lube pad 26.

The sensing device, such as a hydraulic sensor or electronic sensor 44, may be incorporated in the pump 20, for example, to sense at least one or more of centrifugal stage pressure rise, high pressure gear stage pressure rise, pump speed, or the temperature of the bearing lube fluid which is an indication of the bearing load limit. Alternately, the sensor may sense another desired parameter of pump operation. In response to the sensor 44 providing a signal 42 indicative of a predetermined sensed centrifugal or gear stage pressure, pump speed, and/or bearing lube fluid temperature, the valve 40 is operated (e.g., actuated) to open the secondary bearing feed orifice 34, allowing more flow to the bearing 22 and more load carrying capability.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” throughout the specification is to be construed broadly and is used to provide non-limiting examples of embodiments of the disclosure, and the disclosure is not limited to such examples. The use of “connected” or “connection” should be construed broadly and is intended to include, without limitation, direct or indirect physical connection and/or electrical connection (e.g., wired and/or wireless). It is intended that all matter contained in the above description or shown in the accompanying drawings shall be interpreted as illustrative only and not limiting. Changes in detail or structure may be made without departing from the present disclosure as defined in the appended claims.

What is claimed is:

1. A pump, comprising
a bearing having a cavity;
a journal rotatably received in the bearing cavity;
first and second bearing flow feed paths from a bearing lube supply source that provide a bearing fluid to the cavity; and
a control mechanism that selectively alters the amount of bearing fluid flow through at least one of the first and second bearing flow feed paths to the bearing cavity.

2. The pump of claim 1 wherein the control mechanism includes a valve operatively associated with the second bearing flow feed path configured to selectively control the bearing fluid flow.

3. The pump of claim 1 wherein the valve is an on/off valve to selectively permit/prevent bearing fluid flow through the second feed path, respectively.

4. The pump of claim 2 further comprising a sensor that provides a signal representative of at least one of (a) pump speed, (b) pump load, pump pressure, and bearing lube fluid temperature.

5. The pump of claim 4 wherein the sensor monitors system pressure rise.

6. The pump of claim 4 wherein the sensor monitors pressure downstream of the pump.

7. The pump of claim 4 wherein the sensor monitors rotational speed of the journal.

8. The pump of claim 4 wherein the sensor monitors a temperature of the bearing lube fluid.

9. The pump of claim 8 wherein both of the first and second feed paths separately communicate with the bearing lubrication pad.

10. An aircraft engine fuel gear pump, comprising
a bearing having a cavity;
a journal received in the bearing cavity for movement relative thereto;
first and second feed paths that deliver fuel to the bearing cavity; and
wherein at least one of the first and second high pressure fuel feeds includes a control mechanism configured to selectively control at least one of the fuel feed paths with which it is operatively associated.

11. The aircraft engine fuel gear pump of claim 10 wherein the control mechanism includes a valve that selectively controls an amount of bearing flow feed from at least one of the first and second feed paths to the bearing cavity.

12. The aircraft engine fuel gear pump of claim 11 further comprising a sensor that provides a signal representative of at least one of (a) gear pump speed, and (b) gear pump load.

13. The aircraft engine fuel gear pump of claim 12 wherein the signal from the sensor communicates with the control mechanism to vary an amount of flow through at least the one of the first and second feed paths to the bearing cavity.

14. The aircraft engine fuel gear pump of claim 13 wherein the sensor monitors at least one of pump speed or pump pressure.

15. A method of controlling flow to a pump bearing comprising:
providing a bearing and at least different, first and second pressurized feed paths from a bearing lube supply source to a lube pad disposed on an inside diameter of the bearing, each of the first and second pressurized feed paths including an orifice and at least one of the first and second pressurized feed paths including a valve configured to selectively control the feed path and orifice within which it is installed;
sensing at least one condition of pressure or speed of the pump; and
operating the valve in response to at least one of the sensed pressure, sensed pump speed, and sensed temperature of the bearing lube fluid.

16. The method of claim 15 wherein the valve operating step includes altering bearing lube flow through the at least one pressurized feed path.

17. The method of claim 16 wherein the flow altering step includes selectively shutting off bearing lube flow through the at least one pressurized feed path.

18. The method of claim 17 wherein the bearing lube flow is provided through both of the first and second lube flow feed paths in response to at least one of a detected increased pressure rise, detected increased pump speed, or change in bearing lube fluid temperature.

19. The method of claim 15 wherein the sensing is either hydraulic or electronic sensing.

20. The method of claim 15 further comprising using fuel as the bearing lube flow.
